(19) United States
(12) Patent Application Publication
(10) Pub. No.: US 2015/0365889 A1
(43) Pub. Date: Dec. 17, 2015

(54) System and Method Employing Resource Sharing to Reduce Power Consumption by a Network Node

(71) Applicant: Telefonaktiebolaget L M Ericsson (publ), Stockholm (SE)

(72) Inventors: Karupaiah Rajendran, Bangalore (IN); Eeswara Chandra Srikanth Pulugurta, Bengaluru (IN); Debasish Sarkar, Irvine, CA (US)

(21) Appl. No.: 14/305,577

(22) Filed: Jun. 16, 2014

(51) Int. Cl. H04W 52/02; H04W 72/04

(52) U.S. Cl. CPC H04W 52/0206; H04W 72/0486; H04W 72/0493

(57) ABSTRACT

According to some embodiments, a method for reducing power consumption in a network node includes determining that physical resource block utilization by a first radio unit is less than a predefined threshold and at least one condition is present indicating the feasibility of the second radio unit for handling service to the first sector and the second sector. The second radio unit is reconfigured to provide service to the first sector.

### TECHNICAL FIELD

Particular embodiments relate generally to wireless communications and more particularly to a system and method employing resource sharing to reduce power consumption by a network node.

### BACKGROUND

Within an LTE network, a radio base station, which may also be referred to as a network node, includes the hardware and software for connecting wireless devices such as mobile phones with the wireless network. Specifically, a network node may include a digital unit and multiple radio units. A radio unit may be housed in the same cabinet as the digital unit. Alternatively, the radio unit may be a remote radio unit that is self-contained units connected to the digital over extended Common Public Radio Interfaces (CPRIs). The digital unit may include a processor, memory, and timing unit that cooperate to provide baseband processing in the control plane and user plane, synchronization, processing for LTE functions such as radio access control and O&M, and other functions. The radio units provide modulation and demodulation of baseband signals to various Radio Frequency (RF) bands and RF power amplification and filtering.

Within the network node, each radio unit is responsible for transmitting and receiving communications within a distinct cell site or cell sector. As a result, when a radio unit fails, coverage to that cell site is lost until the radio unit can be replaced or fixed. Coverage of a failing radio unit cannot be transferred to an operational radio unit even where the operational radio unit is in under reduced load conditions and is able to handle the additional traffic. Coverage failure and inefficient use of network node resources is a concern for network operators.

Another concern for network operators is the efficiency or inefficiency of network node components in their consumption of power. The characteristics and configuration of such components can influence the amount of power consumed by the network node. For example, a radio unit that is transmitting with a multi input multi output (MIMO) configuration requires more power than a radio unit transmitting with a single input multi output (SIMO) configuration. Likewise, a radio unit that is transmitting with a SIMO configuration requires more power than a radio unit transmitting with a single input single output (SISO) configuration. However, network nodes are not able to dynamically switch from a MIMO configuration to a SIMO or SISO configuration based on network traffic and load conditions.

Additionally, the amount of active traffic being handled by a network node also influences the power consumption by the network node. Specifically, a cell site that is fully loaded consumes more power than a cell site that is not fully loaded. In reality, the cell sites in a given market will not be fully loaded 100% of the time. Rather, the cell sites typically experience down time at some point during a 24 hour period. This period of reduced load may include the approximately six hours in a day in which most humans in a market are sleeping. Thus, it is common for the load on the cell sites in a given market area to fall below 25% during at least 25% of the day. In some cell sites, the load may fall to zero, indicating a no load condition. During such periods of inactivity, the cell sites consume less power than when the cell sites are loaded. However, even under no or low load conditions, some amount of power is required for the transmission of control messages transmitted to maintain coverage and allow subscriber mobility.

Providing efficient use of network resources while maintaining cell coverage and reducing power consumption remains a concern for network operators.

### SUMMARY

Particular embodiments of the present disclosure may provide solutions to reduce power consumption in a network node based on cell loading. Certain embodiments may include redundancy and resource sharing functionality for reducing power consumption by a network node.

According to some embodiments, a network node for reducing power consumption includes a transceiver comprising a plurality of radio units. The network node further includes one or more processors and a non-transitory computer-readable storage medium. The computer-readable storage medium includes computer-readable instructions that are configured when executed to determine that physical resource block utilization by a first radio unit is less than a predefined threshold and that at least one condition is present indicating the feasibility of the second radio unit for handling service to the first sector and the second sector. The second radio unit is reconfigured to provide service to the first sector.

According to some embodiments, a method for reducing power consumption in a network node includes determining that physical resource block utilization by a first radio unit is less than a predefined threshold and at least one condition is present indicating the feasibility of the second radio unit for handling service to the first sector and the second sector. The second radio unit is reconfigured to provide service to the first sector.

According to some embodiments, a network node for reducing power consumption includes a transceiver comprising a plurality of radio units, one or more processors, and a non-transitory computer-readable storage medium that includes computer-readable instructions. The computer-readable instructions are configured, when executed by the one or more processors, to determine that physical resource block utilization by a first radio unit is less than a predefined threshold and the first radio unit is operating with a multi-input multi-output (MIMO) configuration. The one or more processors also determine that the number of active wireless devices service by the first radio unit is less than a second predefined threshold. The first radio unit is reconfigured to provide service for at least one of the plurality of radio units, and at least one of the plurality radio units other than the first radio unit is disabled.

According to some embodiments, a method for reducing power consumption in a network node includes determining that physical resource block utilization by a first radio unit is less than a predefined threshold and the first radio unit is operating with a multi-input multi-output (MIMO) configuration. It is also determined that the number of active wireless devices service by the first radio unit is less than a second predefined threshold. The first radio unit is reconfigured to provide service for at least one of the plurality of radio units, and at least one of the plurality radio units other than the first radio unit is disabled.

Some embodiments of the disclosure may provide one or more technical advantages. For example, certain embodiments may reduce energy consumption by sharing radio unit hardware among cell sectors of a network node. Specifically, one or more radio units under reduced or no load conditions may be shared with other cell sectors in the same network node. In certain embodiments, MIMO and CDD configurations may be dynamically tuned. For example, a network node may be dynamically switched from a MIMO configuration to a SISO or SIMO configuration based on user load and current quality of service requirements.

Another technical advantage may be that operational expenses may be significantly reduced through energy saving and resource sharing. In certain embodiments, low load and no load cell sectors may be identified for resource sharing to reduce energy consumption. In certain embodiments, the Self Organizing Network (SON) Energy Saving function may be optimized to enable resource sharing based on active cell load while maintaining the same radio coverage with no compromise on live traffic capacity.

Another technical advantage may be that the determination that resource sharing should be implemented may be made based on the loading of the cell sectors in combination with user-defined thresholds. Additionally, the SON algorithm may be optimized to optionally check for PCI confusion and/or prevent maximum limits for cell neighbors from being exceeded prior to enabling radio unit sharing. If any such confusion exists or if maximum limits are exceeded, the radio unit services may not be shared.

Still another technical advantage may be that basic radio coverage may be provided with reduced radio throughput capacity. Energy consumption by multiple radio units may be optimized when radio unit capacity is no longer needed. Each cell sector within a network node may alternate between normal operating mode and a resource sharing/energy saving modes based on instantaneous demand. However, still another technical advantage may be that deactivated radio units may be reactivated as needed based on cell sector load.

Still another technical advantage may be that shared resources can be used to restore coverage loss where radio unit hardware can be lent or otherwise donated when a radio unit fails. In certain embodiments, the MIMO switching decision may be made by the optimized SON algorithm to avoid single point failure in the case of a faulty radio unit. As a result, sector coverage may not be lost and faulty equipment can be replaced during off-peak hours. Another technical advantage may be that operating a radio unit in a resource sharing mode may increase cell availability and reduce power consumption if the radio unit is also operating in a load balancing mode.

Some embodiments may benefit from some, none, or all of these advantages. Other technical advantages may be readily ascertained by one of ordinary skill in the art.

### BRIEF DESCRIPTION OF THE DRAWINGS

For a more complete understanding of the present invention and its features and advantages, reference is now made to the following description, taken in conjunction with the accompanying drawings, in which:

FIG. 1 is a block diagram illustrating an example of a network in which power consumption may be reduced according to certain embodiments;

FIG. 2 is a block diagram illustrating an example network node configured to reduce power consumption according to certain embodiments;

FIG. 3 is a switch diagram illustrating an example radio unit array configured for operation in a normal mode according to certain embodiments;

FIG. 4 is a switch diagram illustrating an example radio unit array configured for operation in a resource sharing mode according to certain embodiments;

FIG. 5 is a flow chart illustrating an example embodiment of a method for providing resource sharing for addressing radio unit failure according to certain embodiments;

FIG. 6 is a flow chart illustrating an example alternative embodiment of a method for reducing power consumption by sharing resources in a network node;

FIG. 7 is a switch diagram illustrating an alternative example radio unit array configured for operation in a resource sharing mode according to certain embodiments;

FIG. 8 is a switch diagram illustrating still another alternative example embodiment enabling the sharing of resources in a network node;

FIG. 9 is a flow chart illustrating an example embodiment of a combined method for providing resource sharing and reducing power consumption in no load or low load conditions or in response to device failure;

FIG. 10 is a block diagram illustrating embodiments of a wireless device; and

FIG. 11 is a block diagram illustrating embodiments of a core network node.

### DETAILED DESCRIPTION

Particular embodiments of the present disclosure may provide solutions enabling the sharing of resources in a network node to reduce power consumption by the network node. Certain embodiments may include functionality for detecting failure of a radio unit and reconfiguring an operational radio unit to provide coverage for the failing radio unit. Certain embodiments may additionally or alternatively include functionality for disabling a multi-input multi-output or cyclic delay diversity configuration in an operational radio unit so that the radio unit can provide service coverage for a failing radio unit. Certain embodiments may additionally or alternatively include functionality for determining when a radio unit is underutilized and reconfiguring the radio unit to provide service coverage for at least one other radio unit. Certain embodiments may additionally or alternatively include functionality for determining that a radio unit is in a low load condition and transfer service coverage from the low load radio unit to another radio unit that is able to accommodate the traffic associated with it and the low load radio unit. In each embodiment, at least one radio unit may be disabled to provide energy savings and reduced operating expenses.

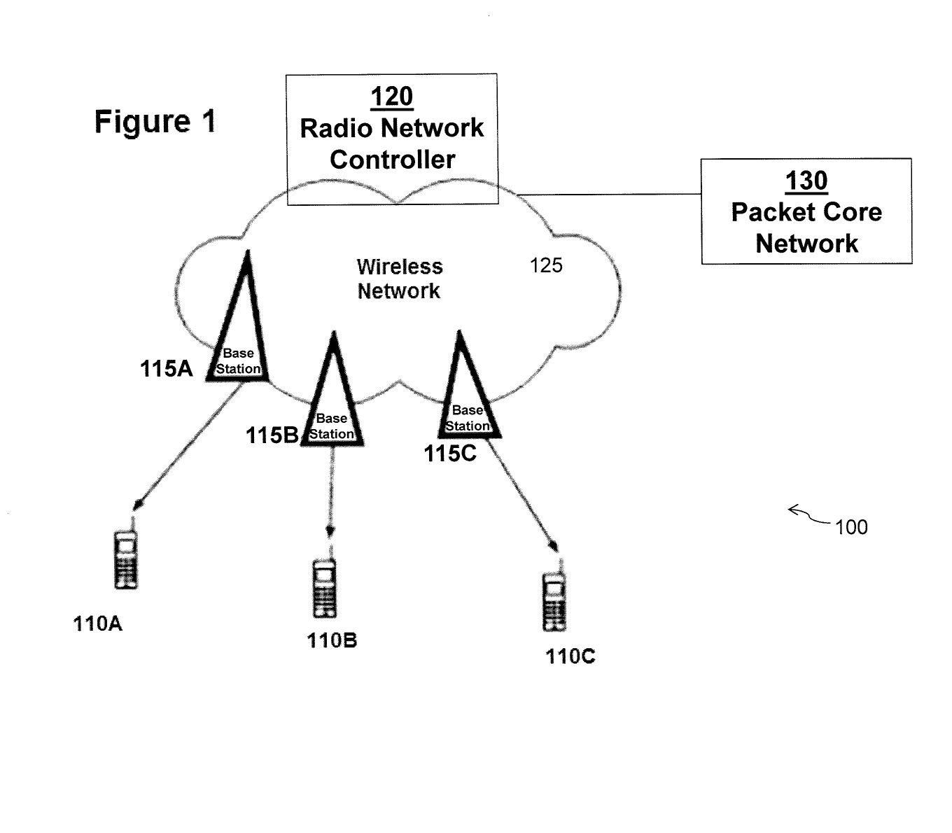

Particular embodiments are described in FIGS. 1-11 of the drawings, like numerals being used for like and corresponding parts of the various drawings. FIG. 1 is a block diagram illustrating an example of a network 100 in which power consumption may be reduced according to certain embodiments. Network 100 includes one or more wireless communication devices 110, a plurality of network nodes 115, radio network controller 120, and a packet core network 130. In the example, wireless communication device 110a communicates with network node 115a over a wireless interface. For example, wireless communication device 110a transmits wireless signals to network node 115a and/or receives wireless signals from network node 115a. The wireless signals contain voice traffic, data traffic, control signals, and/or any other suitable information.

As described with respect to FIG. 1 above, embodiments of network 100 may include one or more wireless communication devices 110, and one or more different types of network nodes capable of communicating (directly or indirectly) with wireless communication devices 110. Examples of the network nodes include network nodes 115, radio network controller 120, and core network nodes 130. The network may also include any additional elements suitable to support communication between wireless communication devices 110 or between a wireless communication device 110 and another communication device (such as a landline telephone).

A network node 115 refers to any suitable node of a radio access network/base station system. Examples include a radio access node (such as a base station or eNodeB) and a radio access controller (such as a base station controller or other node in the radio network that manages radio access nodes). Network node 115 interfaces (directly or indirectly) with core network node 130. For example, network node 115 interfaces with core network node 130 via an interconnecting network 125. Interconnecting network 125 refers to any interconnecting system capable of transmitting audio, video, signals, data, messages, or any combination of the preceding. Interconnecting network 125 may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof.

Core network node 130 manages the establishment of communication sessions and provides various other functionality for wireless communication device 110. Wireless communication device 110 exchanges certain signals with core network node 130 using the non-access stratum layer. In non-access stratum (NAS) signaling, signals between wireless communication device 110 and core network node 130 pass transparently through network nodes 120.

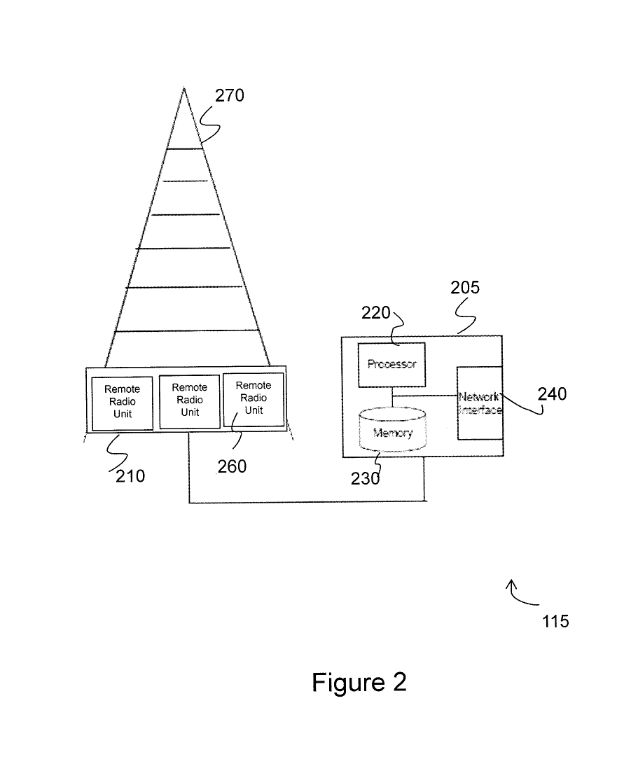

In certain embodiments, wireless communication device 110, network node 120, and core network node 130 use any suitable radio access technology, such as long term evolution (LTE), LTE-Advanced, UMTS, HSPA, GSM, cdma2000, WiMax, WiFi, another suitable radio access technology, or any suitable combination of one or more radio access technologies. For purposes of example, various embodiments may be described within the context of certain radio access technologies. However, the scope of the disclosure is not limited to the examples and other embodiments could use different radio access technologies. Each of wireless communication device 110, network node 115, radio network controller 120, and core network node 130 include any suitable combination of hardware and/or software. Examples of particular embodiments of a network node 115, wireless communication device 110, and core network node 130 are described with respect to FIGS. 2, 10, and 11, respectively.

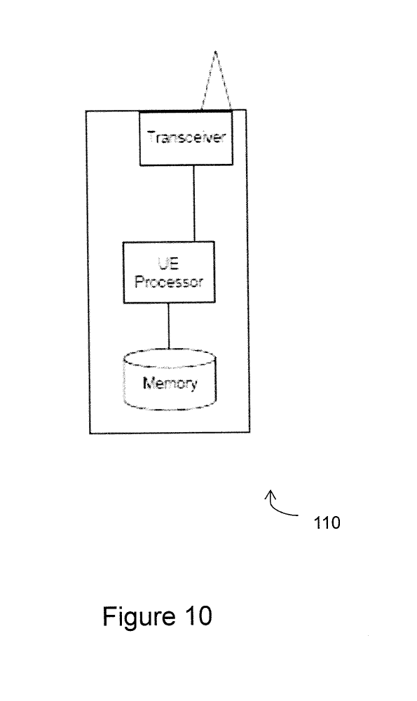

FIG. 2 is a block diagram illustrating embodiments of network node 115 configured for reducing power consumption. In the illustration, network node 115 is shown as a radio access node, such as an eNodeB, a node B, a base station, a wireless access point (e.g., a Wi-Fi access point), a low power node, a base transceiver station (BTS), transmission points, transmission nodes, remote RF unit (RRU), remote radio head (RRH), etc. Other network nodes 115, such as one or more radio network controllers, may be configured between the radio access nodes and core network nodes 130. These other network nodes 115 may include processors, memory, and interfaces similar to those described with respect to FIG. 10, however, these other network nodes might not necessarily include a wireless interface, such as transceiver 210.

Radio access nodes are deployed throughout network 100 as a homogenous deployment, heterogeneous deployment, or mixed deployment. A homogeneous deployment generally describes a deployment made up of the same (or similar) type of radio access nodes and/or similar coverage and cell sizes and inter-site distances. A heterogeneous deployment generally describes deployments using a variety of types of radio access nodes having different cell sizes, transmit powers, capacities, and inter-site distances. For example, a heterogeneous deployment may include a plurality of low-power nodes placed throughout a macro-cell layout. Mixed deployments include a mix of homogenous portions and heterogeneous portions.

As depicted, network node 115 includes a digital unit 205 and a radio unit array 210. Digital unit 205 includes one or more of a processor 220, memory 230, and network interface 240. Radio unit array 210 includes multiple radio units 260 that are each responsible for transmitting and receiving wireless signals within a distinct cell site/sector. In particular embodiments, each radio unit 260 may be selectively configured to transmit in either a multi input multi output (MIMO) configuration, a single input single output (SISO) configuration, or a single input multiple output (SIMO) configuration. Radio unit 260 operating in a MIMO configuration utilizes multiple antennas in antenna system 270 to transmit wireless signals that are received by multiple antennas of wireless device 110. In contrast, a radio unit 260 operating in a SISO configuration utilizes a single antenna to transmit wireless signals that are received by a single antenna of wireless device 110. However, a radio unit 260 operating in a SIMO configuration utilizes a single antenna in antenna system 270 to transmit wireless signals that are received by multiple antennas of a wireless device 110. Operating a radio unit 260 in MIMO configuration may improve communication performance by increasing data throughput and link range. However, a radio unit 260 operating in a MIMO configuration will consume more power than a radio unit 260 that is operated in a SIMO configuration. Likewise, a radio unit operating in a SIMO configuration will consume more power than a radio unit 260 in a SISO configuration. Thus, where load conditions do not warrant use of a MIMO configuration, radio unit 260 may be switched to a SIMO or SISO configuration to realize energy savings.

The wireless signals may be transmitted to and received from wireless communication devices 110 via an antenna system 270. Network interface 240 communicates signals to backend network components, such as a gateway, switch, router, Internet, Public Switched Telephone Network (PSTN), other network nodes 115, radio network controllers 120, core network nodes 130, etc.

Processor 220 includes any suitable combination of hardware and software implemented in one or more modules to execute instructions and manipulate data to perform some or all of the described functions of network node 115, memory 230 stores the instructions executed by processor 220. In some embodiments, processor 220 includes, for example, one or more computers, one or more central processing units (CPUs), one or more microprocessors, one or more applications, and/or other logic.

Memory 230 is generally operable to store instructions, such as a computer program, software, an application including one or more of logic, rules, algorithms, code, tables, etc. and/or other instructions capable of being executed by a processor. Examples of memory 530 include computer memory (for example, Random Access Memory (RAM) or Read Only Memory (ROM)), mass storage media (for example, a hard disk), removable storage media (for example, a Compact Disk (CD) or a Digital Video Disk (DVD)), and/or or any other volatile or non-volatile, non-transitory computer-readable and/or computer-executable memory devices that store information.

In some embodiments, network interface 240 is communicatively coupled to processor 220 and refers to any suitable device operable to receive input for network node 115, send output from network node 115, perform suitable processing of the input or output or both, communicate to other devices, or any combination of the preceding. Network interface 240 includes appropriate hardware (e.g., port, modem, network interface card, etc.) and software, including protocol conversion and data processing capabilities, to communicate through a network.

Other embodiments of network node 115 may include additional components (beyond those shown in FIG. 2) responsible for providing certain aspects of the network node's functionality, including any of the functionality described above and/or any additional functionality (including any functionality necessary to support the solution described above). The various different types of radio access nodes may include components having the same physical hardware but configured (e.g., via programming) to support different radio access technologies, or may represent partly or entirely different physical components.

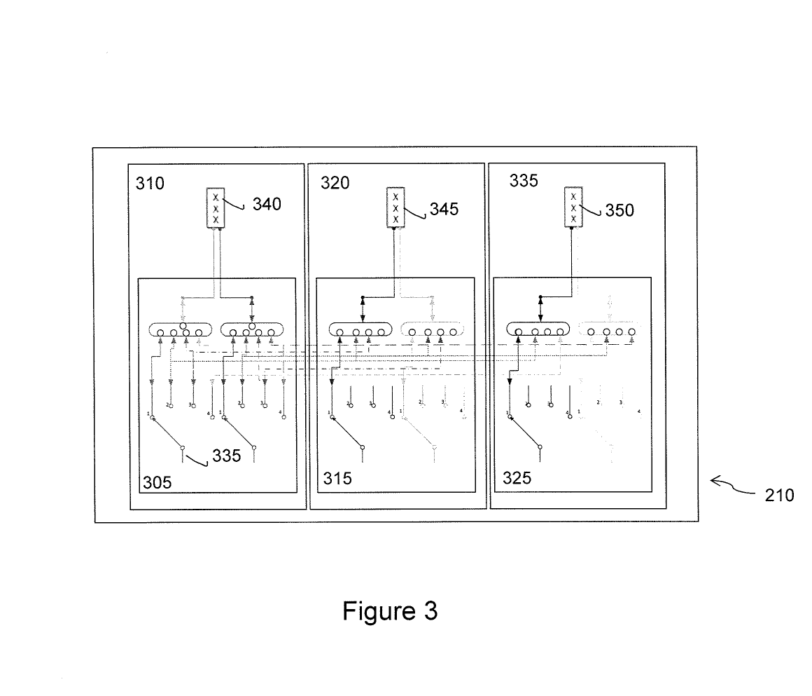

In a normal mode of operation, each radio units 260 in radio unit array 210 is responsible for transmitting and receiving wireless signals within a distinct cell site/sector. FIG. 3 illustrates a switch diagram of a radio unit array 300 configured for operation in a normal mode. As depicted, radio unit array 300 includes three radio units that service three distinct cell sectors. Specifically, alpha radio unit 305 services alpha sector 310, beta radio unit 315 services beta sector 320, and gamma radio unit 325 services gamma sector 330. As depicted, all radio units are operational and configured to transmit and receive wireless signals within their associated sector. Thus, each of alpha radio unit 305, beta radio unit 315, and gamma radio unit 325 have the switch position set to the first position 335. Accordingly, alpha radio unit 305 provides power for the transmission of signals via alpha antenna unit 340, beta radio unit 315 provides power for transmission of signals via beta antenna unit 345, and gamma radio unit 325 provides power for transmission of signals via gamma antenna unit 350.

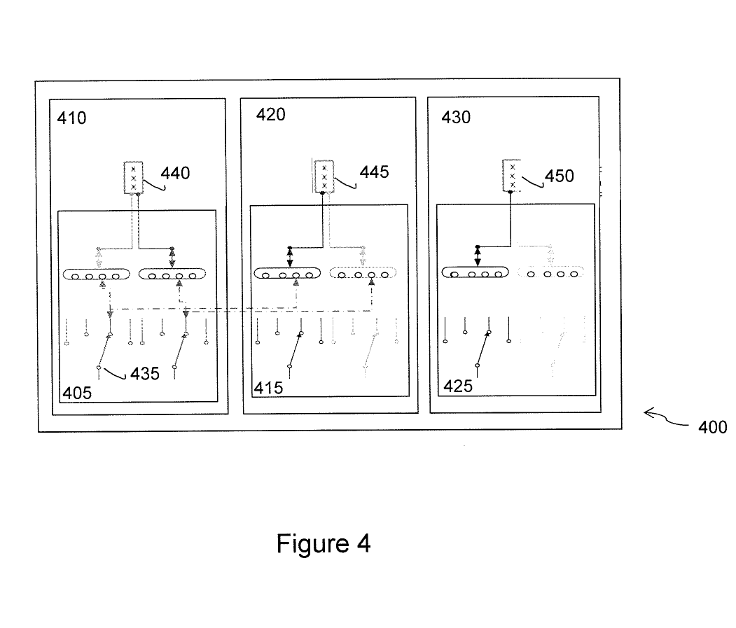

In certain embodiments, however, it may be desirable to operate radio unit array 210 in a resource sharing mode. FIG. 4 illustrates a switch diagram for an example radio unit array 400 configured for operation in a resource sharing mode. Similar to radio unit array 300 depicted in FIG. 3, radio unit array 400 includes three radio units associated with three distinct cell sectors. Specifically, alpha radio unit 405 is associated with alpha sector 410, beta radio unit 415 is associated with beta sector 420, and gamma radio unit 425 is associated with gamma sector 430. Were all radio units active, radio unit array 400 would function like radio unit array 300 of FIG. 3. However, in the depicted embodiment, beta radio unit 415 is not active, and each radio unit 405, 415, and 425 has the switch position set to the third position 435.

Transition of the switch from the first position associated with the normal mode of operation (depicted in FIG. 3) to the third position 435 associated with a resource sharing mode may be achieved either mechanically, electro mechanically, and/or electronically and may result in switching of link points between the radio units and the antennas. For example, in the depicted embodiment, alpha radio unit 405 remains linked to antenna alpha unit 440 to support the transmission of signals via alpha antenna unit 440. Likewise, gamma radio unit 425 remains linked to gamma antenna unit 450 to support the transmission of signals via gamma antenna unit 450. However, because beta radio unit 415 is inactive, link points between alpha radio unit 405 and beta antenna unit 445 are enabled. As a result, alpha radio unit 405 is capable of supporting transmissions to wireless devices 110 in beta sector 420 via beta antenna unit 445.

One scenario in which a radio unit may become inactive is the case of device failure. Such failure may be for a known or unknown reason and may result in wireless coverage being lost in the respective sector. To restore coverage to the sector, previous systems would require the faulty radio unit to be replaced. However, according to certain embodiments, network node 115 may be configured to automatically transition radio unit array 210 to a resource sharing mode when the failure of a radio unit 260 is detected. In such a situation, the antenna unit associated with the failing radio unit 260 may be tapped to a radio unit 260 that is still operational. Thus, wireless service may be maintained within a cell site/sector even when a radio unit 260 fails.

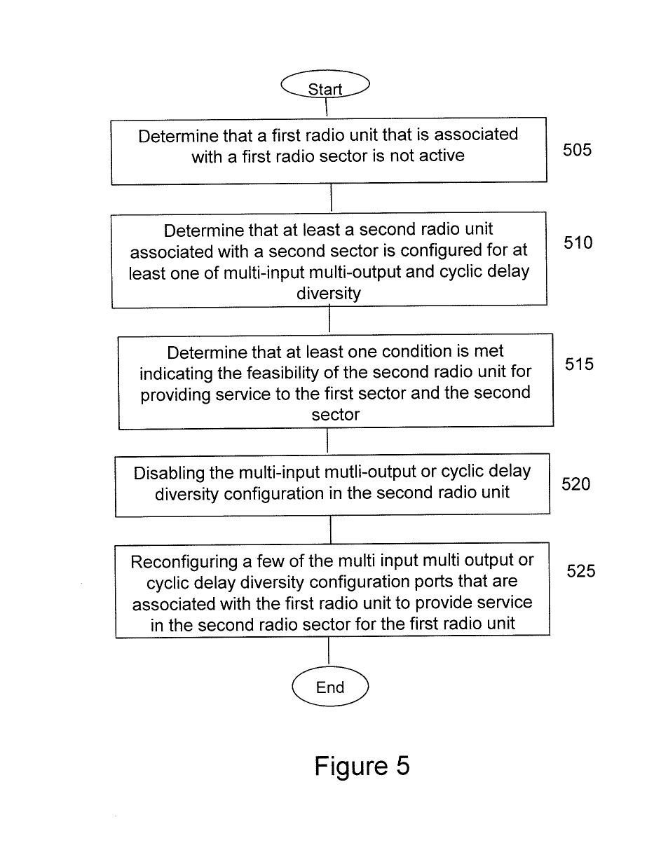

FIG. 5 is a flow chart illustrating an example embodiment of a method for providing resource sharing to address radio unit failure. The method begins at step 505, when it is determined that a first radio unit, such as beta radio unit 415, that is associated with a first radio sector, such as beta radio sector 420, has failed or is otherwise not active. For example, processor 220 or another component of network node 115 may determine that beta radio unit 415 is not transmitting or receiving wireless signals within beta sector 420. As a result, wireless coverage in beta sector 420 is lost.

At step 510, a determination is made that at least a second radio unit, such as alpha radio unit 405, associated with a second sector, such as alpha radio sector 410, is configured for at least one of MIMO and cyclic delay diversity. A determination may then be made as to whether at least one condition is met that indicates the feasibility of the second radio unit for providing service to both the first sector and the second sector at step 515. Thus, in a particular embodiment, processor 220 or another component of network node 115 may operate to determine that alpha radio unit 405 is capable of providing service to both alpha sector 410 and beta sector 420. In a particular embodiment, the one or more conditions that may be met may include alpha radio unit 405 being low loaded with specific user-defined Quality of Service Class Identifier (QCI) sessions being less than a predefined threshold. Additionally or alternatively, the one or more conditions that may be met may include a determination that alpha radio unit 405 is not handling any emergency calls.

At step 520 and in response to determining that the second radio unit can feasibly handle servicing both the sector associated with it and the sector of the first radio unit, the MIMO or cyclic delay diversity (CDD) configuration in the second radio unit may be disabled. Continuing the example depicted in FIG. 4, the MIMO or CDD configuration of alpha radio unit 405 may be disabled. For example, if alpha radio unit 405 was initially operating as a MIMO unit, then alpha radio unit 405 may be transitioned to a SIMO or SISO unit. Doing so will free up antenna ports that are not used when alpha radio unit 405 operates with a single transmitter and receiver.

At step 525, the CDD or MIMO radio ports that were previously used for transmitting in the second radio sector may be reconfigured to transmit in the first radio sector. Stated differently, radio unit link points may be established between the available radio ports of the second radio unit and an antenna unit associated with the first radio sector. Thus, the ports that were freed up when the MIMO configuration was disabled in alpha radio node 405 may be linked to the beta antenna unit 445. In this manner, alpha radio unit 405 may be lent to beta sector 420 and wireless device coverage may be restored to beta sector 420 with minimum loss.

The lending of services by alpha radio unit 405 may continue until faulty beta radio unit 415 is replaced and service restored. The redundancy provided by alpha radio unit 405 may increase cell availability and reduce power consumption if alpha radio unit 405 is operating in a load balancing mode. Additionally, the method may help to avoid single point failure, by preventing loss of sector coverage in the case of a faulty radio unit and allows the faulty radio unit to be replaced during off-peak hours.

It may be recognized that while the beta radio unit 415 is being identified and alpha radio unit 405 is reconfigured to provide service to beta sector 420, there may be brief period of downtime in alpha and beta sectors 410 and 420. The downtime may be associated with the amount of time required for the SON algorithm to generate the new configuration and apply the switch settings. Wireless devices 110 that are served by alpha radio unit 405 may suffer radio frequency signal loss for a brief time. Though the signal loss may last only a fraction of seconds, it may result in Radio Link Failure (RLF) in wireless devices 110 in the alpha and beta sectors 410 and 420. Additionally, the event may trigger an RRC connection Re-establishment request. However, the event may be avoided or the effects thereof reduced by changing certain timing parameters as determined by the SON algorithm or as defined by a user. The timing parameters may be optimized based on Quality of Service (QoS) requirement levels that must be maintained for connected wireless devices 110. In a particular example embodiment, the System Information Block Type 2 parameter comprising the t310 timer value to 2000 ms and a n310 value to n20.

The above described method described using resource sharing to prevent wireless coverage loss as a result of hardware failure in a radio unit array 210. However, it may be desirable to operate a radio unit array 210 in a resource sharing mode even where no failure has been detected. Accordingly, in certain embodiments, a network node 115 may be additionally or alternatively configured to automatically transition to a resource sharing mode when traffic is sufficiently low to render operation of at least one radio unit unnecessary. Doing so may result in the disabling of one or more radio units, which may result in substantial energy savings over a network node in which all radio units are operating in normal mode.

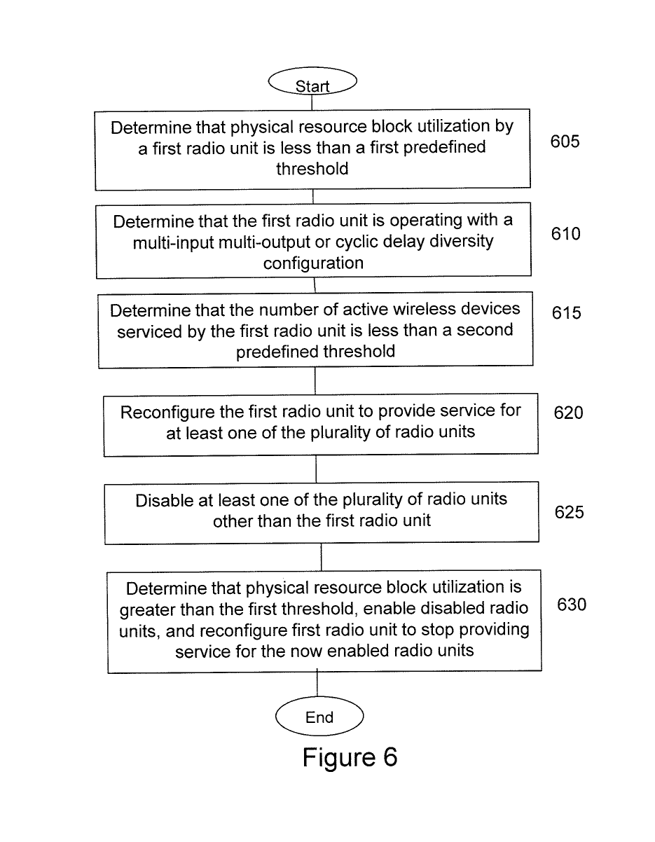

The transition from normal operating mode to a resource sharing mode, which may also be considered an energy saving mode, may be selected by an optimized SON algorithm that operates to determine that a network node 115 is not operating efficiently and adjust the configuration of the network node 115 accordingly. For example, in certain embodiments, the optimized SON algorithm may determine that one or more radio units is at no or low load conditions and then reconfigure the radio unit array 210. FIG. 6 is a flow chart illustrating an example embodiment of a method for enabling resource sharing to reduce energy consumption.

The method begins at step 605 when it is determined that Physical Resource Block (PRB) utilization by a first radio unit 260 is less than a first predefined threshold. In a particular embodiment, PRB utilization may include the sum of the total number of physical resource block (PRB) pairs used for data radio bearers in the downlink (pmPrbUsedDlDtch) and the total number of PRB pairs used for data radio bearers in the uplink (pmPrbUsedUlDtch). The pmPrbUsedDlDtch measurement may be applicable to the Dedicated Traffic Channel (DTCH) on the Physical Downlink Shared Channel (PDSCH). Conversely, the pmPrbUsedUlDtch measurement may be applicable to the DTCH on the Physical Uplink Shared Channel (PUSCH). In certain embodiments, the first predefined threshold may be thirty percent. Thus, it may be determined that PRB utilization is less than thirty percent. However, it is generally recognized that the first predefined threshold may be a user-selected value that varies as is appropriate.

At step 610, it is determined that the first radio unit 260 is operating with a MIMO configuration. It is then determined at step 615 that the number of active wireless devices 110 being serviced by the first radio unit 260 is less than a second predefined threshold at step 615. In a particular embodiment, processor 220 may include a counter for determining the number of wireless devices 110 being actively serviced in both the downlink and uplink directions. Specifically, a counter may aggregate for each TTI, the number of wireless devices in the downlink direction with DRB data to send. Likewise, the counter may aggregate for each TTI the number of wireless devices 110 with buffer status reports indicating DRB data to be sent in the uplink direction. Processor 220 may then sum the number of wireless devices 110 considered active in the downlink direction (pmActiveUeDISum) and the number of wireless devices considered active in the uplink direction (pmActiveUeUISum) and determine if the sum is less than the second predefined threshold. In a particular embodiment, the determination may require that the sum of pmActiveUeDlSum and pmActiveUeUlSum is equal to zero, indicating that the cell sector is under a no load condition.

In some embodiments, the determination requires that the number of active wireless devices 110 is maintained below the second predefined threshold for a predetermined interval of time. Thus, in a particular embodiment, a determination must be made that the PRB utilization is less than the second predefined threshold for at least fifteen minutes. However, it is generally recognized that the predefined threshold and predefined interval may be dynamically changed based on historical data processing and/or user input and may vary as appropriate.

At step 620, the first radio unit 260 may be reconfigured to provide service for at least one other radio unit 260. In certain embodiments, reconfiguring first radio unit 260 may include disabling the MIMO or CDD configuration in the first radio unit 260. As described above, disabling the MIMO or CDD configuration will free up antenna ports that are not used when first radio unit 260 operates with a single transmitter and receiver. The CDD or MIMO radio ports that were previously used for transmitting in the first radio sector may then be reconfigured to provide service to an antenna units associated with the at least one other radio unit 260.

At step 625, one or more radio units 210 are disabled and first radio unit 260 is lent to the associated sectors. Because one radio unit 260 may be used to support transmissions in two or more sectors and at least one radio unit 260 can be disabled, substantially energy savings may be realized. In the scenario described above where the radio unit array 210 includes three radio units 260 and first radio unit 260 is reconfigured to support one other cell sector of network node 115, the switch configuration of FIG. 4 may be applicable. Thus, alpha radio unit 405 is reconfigured to support beta antenna unit 445.

In certain embodiments, the method may continue to step 630. At step 630, it may be determined, at some point after the reconfiguration of first radio unit 260 and disabling of at least one other radio unit, that PRB utilization by the first radio unit is more than a predefined threshold. Radio units 260 that were previously disabled may be enabled again to reduce the load on first radio unit 260. First radio unit 260 may be reconfigured to cease providing service for now enabled radio units 260.

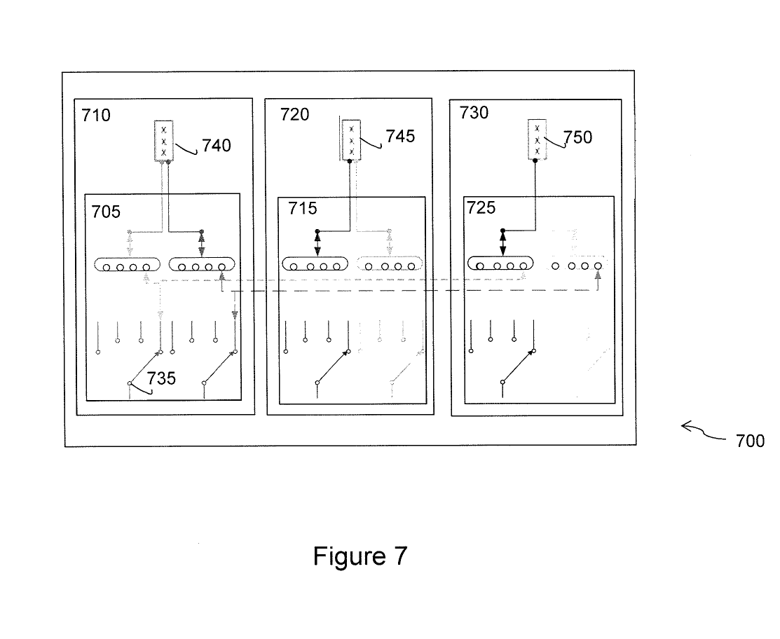

Though alpha radio unit 405 is described as being reconfigured to support beta sector 420 with regard to FIG. 6, certain embodiments may result in alpha radio unit 405 being reconfigured to support gamma sector 430 instead. FIG. 7 is a switch diagram illustrating an alternative example radio unit array 700 configured for operation in a resource sharing mode. Similar to radio unit array 300 and radio unit array 400 depicted in FIGS. 3 and 4, respectively, radio unit array 700 includes three radio units associated with three distinct cell sectors. Specifically, alpha radio unit 705 is associated with alpha sector 710, beta radio unit 715 is associated with beta sector 720, and gamma radio unit 725 is associated with gamma sector 730. In the depicted embodiment, gamma radio unit 725 is not active, and each radio unit 705, 715, and 725 has the switch position set to the fourth position 735.

Transition of the switch from the first position associated with the normal mode of operation to the fourth position 735 associated with a resource sharing mode may be achieved either mechanically, electro mechanically, and/or electronically and may result in switching of link points between the radio units and the antennas. For example, in the depicted embodiment, alpha radio unit 705 remains linked to antenna alpha unit 740 to support the transmission of signals via alpha antenna unit 705 and beta radio unit 715 remains linked to beta antenna unit 745 to support the transmission of signals via beta antenna unit 745. However, gamma radio unit 725 is disabled, and link points between alpha radio unit 705 and gamma antenna unit 750 are enabled. As a result, alpha radio unit 705 is capable of supporting transmissions to wireless devices 110 in both alpha sector 710 via antenna unit 740 and gamma sector 730 via gamma antenna unit 750. Because a radio unit is disabled, radio unit array 700 may result in substantial energy savings over a radio unit array operating in the normal mode of operation described above.

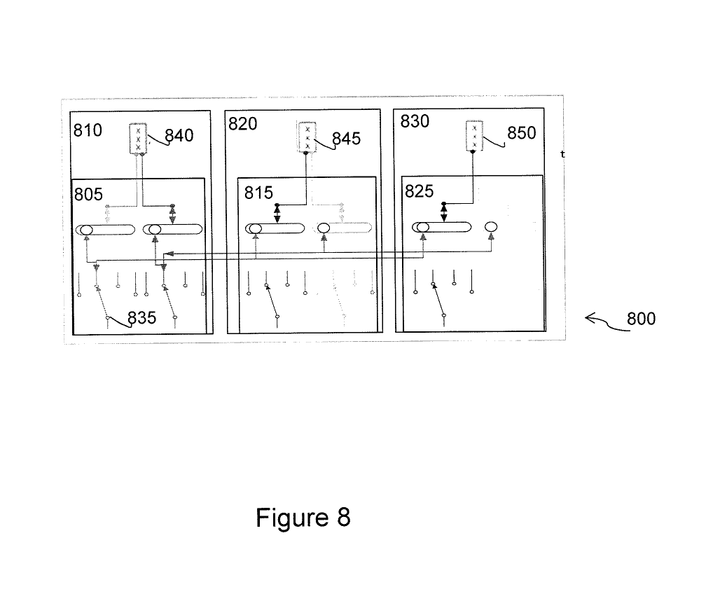

In still other embodiments, even further energy savings may be realized where a radio unit is reconfigured to support every cell sector of network node 115 and every other radio unit may be disabled. To operate in this manner, the switch configuration is adapted. FIG. 8 illustrates another alternative example radio unit array 800 configured for operation in a resource sharing mode that results in maximized energy savings. Similar to radio unit arrays 300, 400, and 700 illustrated in FIGS. 3, 4, and 7, respectively, radio unit array 800 includes three radio units associated with three distinct cell sectors. Specifically, alpha radio unit 805 is associated with alpha sector 810, beta radio unit 815 is associated with beta sector 820, and gamma radio unit 825 is associated with gamma sector 830. In the depicted embodiment, beta and gamma radio units 815 and 825 are not active, and each radio unit 805, 815, and 825 has the switch position set to the second position 835.

Transition of the switch from the first position associated with the normal mode of operation to the second position 835 associated with a resource sharing mode may be achieved either mechanically, electro mechanically, and/or electronically and may result in switching of link points between the radio units and the antennas. For example, in the depicted embodiment, alpha radio unit 805 remains linked to alpha antenna unit 840 to support the transmission of signals via alpha antenna unit 840. However, beta radio unit 815 and gamma radio unit 825 are disabled. Link points between alpha radio unit 805 and gamma antenna unit 850 are enabled. Likewise, link points between alpha radio unit 805 and beta antenna unit 845 are enabled. As a result, alpha radio unit 805 is able to support transmissions to wireless devices 110 in both in all three sectors. Because the beta and gamma radio units 815 and 825 are disabled, radio unit array 800 may result in the greatest energy savings.

Though the switch configuration of FIG. 8 is appropriate where it is determined cell sector loading in all cell sectors can be accommodated by a single radio unit 260, it is equally appropriate where all but one radio unit 260 in a network node 115 have failed. Where the radio unit load satisfies certain user defined threshold conditions and desired Quality of Service levels may be maintained.

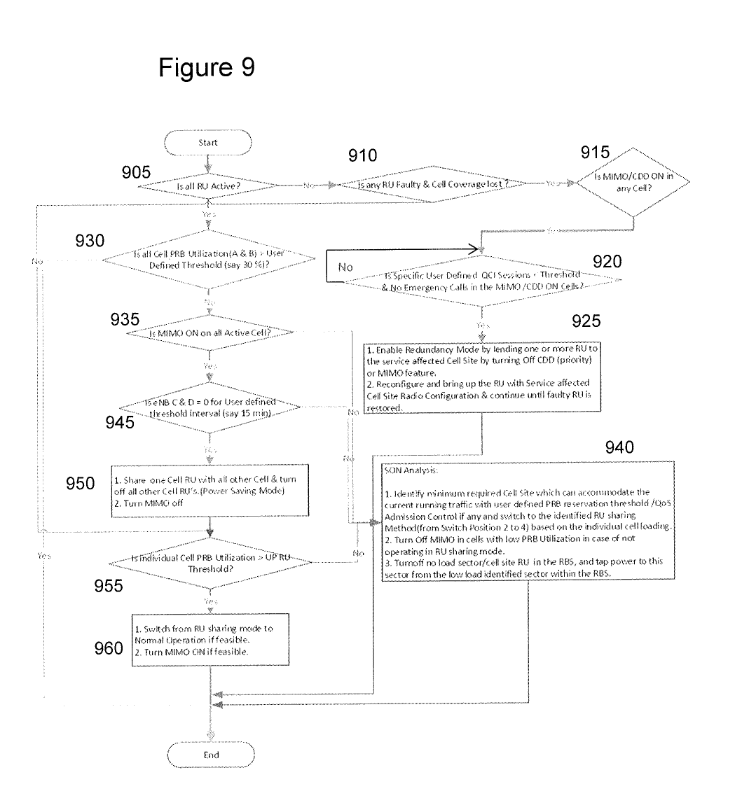

FIG. 9 is a flow chart illustrating another example embodiment of an alternative method for reducing power consumption by sharing resources in a network node. The method begins at step 905 when it is determined whether all radio units are active. If not at all radio units are active, it may then be determined at step 910 whether any of the radio units 260 have failed and cell coverage has been lost. If a radio unit has failed, it may be determined whether any non-failing radio units 260 are operating with a MIMO or CDD configuration at step 915.

If at least one radio unit 260 is operating with a MIMO or CDD configuration, it may be determined at step 920 whether specific user-defined QCI sessions in the radio unit that is operating in the MIMO or CDD configuration is less than a predefined threshold. Additionally, it may be determined whether or not the radio unit 260 operating with a MIMO or CDD configuration is handling any emergency calls. If step 920 is answered negatively, the determination of step 920 may be repeated until it is affirmatively answered.

When 920 is affirmatively answered, a redundancy/resource sharing mode may be enabled by lending one or more radio units to the failing cell sector at step 925. In certain embodiments, enabling the redundancy/resource sharing mode may include turning off the CDD or MIMO configuration in the radio unit 260 that has been selected for providing resource sharing. For example, if the selected radio unit 260 was initially operating as a MIMO unit, then the selected radio unit 260 may be transitioned to a SIMO or SISO unit. Doing so will free up antenna ports that are not used when the selected radio unit 260 operates with a single transmitter and receiver. In certain embodiments, enabling the redundancy/resource sharing mode may include reconfiguring the CDD or MIMO radio ports that were previously used for transmitting in the radio sector associated with the selected radio unit 260. Stated differently, radio unit link points may be established between the available radio ports of the selected radio unit 260 and an antenna unit associated with the failing radio sector. In this manner, the selected radio unit 260 may be lent to the failing sector and wireless device coverage may be restored to the failing sector with minimum loss. The lending of services by the selected radio unit 260 may continue until the failing radio unit 260 is replaced and service restored. Then method may then terminate.

Returning to step 905, if it is determined that all radio units 260 are active, it may be determined whether any cell sector has a PRB utilization that is greater than a user defined threshold at step 930. As discussed above, the PRB utilization may include the sum of the total number of physical resource block (PRB) pairs used for data radio bearers in the downlink (pmPrbUsedDlDtch) and the total number of PRB pairs used for data radio bearers in the uplink (pmPrbUsedUlDtch) in a particular embodiment. The pmPrbUsedDlDtch measurement may be applicable to the Dedicated Traffic Channel (DTCH) on the Physical Downlink Shared Channel (PDSCH). Conversely, the pmPrbUsedUlDtch measurement may be applicable to the DTCH on the Physical Uplink Shared Channel (PUSCH). In certain embodiments, the first predefined threshold may be thirty percent. Thus, in a particular embodiment, it may be determined that at least one cell sector has a PRB utilization that is less than thirty percent. However, it is generally recognized that the first predefined threshold is provided for example purposes and may vary as appropriate.

If a cell sector is determined to have a PRB utilization that is less than the first predefined threshold, the cell sector may be identified as a low load cell sector. The method then continues to step 935. At step 935, it is determined whether any active radio unit 260 is operating with a MIMO or CDD configuration. If no active radio unit 260 is operating with a MIMO or CDD configuration, the SON analysis may be performed at step 940 to identify a radio unit which can accommodate the current running traffic in the low load cell sector based on active traffic each cell sector. In certain embodiments, the identified radio unit 260 must be able to handle the additional traffic of the cell sector identified as a low load sector in step 930 while maintaining a user defined PRB reservation threshold and/or satisfying QoS admission control. The network node may then be switched to the resource sharing mode that will permit the identified radio unit to provide service to the low load cell sector. Power may be tapped from the identified radio unit and provided to the antenna unit associated with the low load cell sector. The radio unit 260 associated with the low load cell sector may then be disabled and the method may terminate.

Returning to step 935, if it is determined that an active radio unit is operating with a MIMO or CDD configuration, the method may continue to step 945. At step 945, it is determined whether the number of active wireless devices 110 being serviced by the active radio unit 260 having the MIMO or CDD configuration is equal to zero, indicating a no load cell sector. In some market areas, a cell sector may experience a no load condition for up to six hours per day. This time corresponds generally with the amount of time that users of wireless devices in the market area spend sleeping.

In a particular embodiment and as discussed above, processor 220 may include a counter for determining the number of user devices being actively serviced in both the downlink and uplink directions. Specifically, a counter may aggregate for each TTI, the number of wireless devices in the downlink direction with DRB data to send. Likewise, the counter may aggregate for each TTI the number of wireless devices with buffer status reports indicating DRB data to be sent in the predefined direction. Processor 220 may then sum the number of wireless devices considered active in the downlink direction (pmActiveUeDlSum) and the number of wireless devices considered active in the uplink direction (pmActiveUeUlSum) and determine if the sum has been equal to zero for a predefined interval of time. In a particular embodiment, for example, it may be determined whether the number of wireless devices has been equal to zero for at least fifteen minutes. However, the predefined interval may include any period of time appropriate for determining that the radio unit is under a no load condition. In a certain embodiments, the predefined time interval may be dynamically adjusted based on historical data processing.

If the number of active units has not been equal to zero for the predefined interval of time, the method returns to step 940. At step 940, the SON analysis may be performed to identify a low load a radio unit which can accommodate the low load sector based on current cell sector loading. In a particular embodiment, any identified radio unit 260 must be able to handle the additional traffic of the low load sector while maintaining a user defined PRB reservation threshold and/or satisfying QoS admission control. The network node may then be switched to the resource sharing mode that will permit the identified radio unit to provide service to the low load cell sector. Power may then be tapped from the identified radio unit and provided to the low load cell sector. The radio unit 260 associated with the low load cell sector may then be disabled and the method may terminate.

If at step 940, however, no radio unit 260 is identified as being able to accommodate servicing the no or low load cell sector, then the radio unit 260 experiencing the no or low load condition may be switched from a MIMO configuration to a SIMO or SISO configuration if there are no wireless devices 110 in the sector operating in spatial multiplexing mode. In this manner, even where radio unit sharing is not possible due to load conditions, the configuration of a radio unit experiencing no or low load conditions can be optimized to result in energy savings if transmit diversity gain is not significant.

Returning to step 945, if it is determined that the number of active wireless devices served by the radio unit 260 that is configured for MIMO has been equal to zero for at least the predefined time interval the method continues to step 950. At step 950, the identified radio unit 260 is reconfigured for resource sharing/energy saving mode. In certain embodiments, the MIMO configuration may be disabled. Power may then be tapped from the identified radio unit 260 to all other cell sectors and all other radio units 260 may be disabled.

At step 955, it may be determined whether the individual cell PRB utilization in the now only operating radio unit 260 is greater than an uplink radio unit threshold. If the PRB utilization is not greater than the threshold, the SON analysis of step 940 may be performed to identify another radio unit 260 that can accommodate the current running traffic based on current cell sector loading. In a particular embodiment, any identified radio unit 260 must be able to handle the additional traffic of the low load sector while maintaining a user defined PRB reservation threshold and/or satisfying QoS admission control. The network node may then be switched to the resource sharing mode that will permit the newly identified radio unit to provide service to all cell sectors. Power may then be tapped from the newly identified radio unit and provided to each cell sector. All other radio units 260 may remain disabled and the method will terminate.

If at step 955, it is determined instead that the individual cell PRB utilization is not greater than the uplink radio unit threshold, the method continues to step 960. At step 960, the network node may be switched from the resource sharing/energy saving mode to the normal mode if feasible. MIMO or CDD may be configured if feasible.

Returning to steps 905 and 910, if it is determined that at least one radio unit is inactive but not failing, the method continues to step 955. At step 955, it may be determined whether the individual cell PRB utilization in the operating radio unit 260 is greater than an uplink radio unit threshold. If the PRB utilization is not greater than the threshold, the SON analysis of step 940 may be performed to identify a radio unit 260 that can accommodate the current running traffic based on current cell sector loading. In a particular embodiment, any identified radio unit 260 must be able to handle the additional traffic of the inactive radio unit 260 while maintaining a user defined PRB reservation threshold and/or satisfying QoS admission control. The network node may then be switched to the resource sharing mode that will permit the identified radio unit to provide service to the cell sector associated with the inactive radio unit. Power may then be tapped from the identified radio unit and provided to the cell sector associated with the inactive radio unit. The method may then terminate.

If at step 955, it is determined instead that the individual cell PRB utilization is not greater than the uplink radio unit threshold, the method continues to step 960. At step 960, the network node may be switched from the resource sharing/energy saving mode to the normal mode if feasible. Additionally, MIMO and CDD may be configured if feasible.

Modifications, additions, or omissions may be made to the steps depicted in FIG. 9 without departing from the scope of the invention. The steps may be performed in any suitable order. Additionally, the methods may include more, fewer, or other steps. For example, in certain embodiments, additional checks may be performed to determine whether radio unit resource sharing should not be implemented. For example, the SON algorithm may be optimized to optionally check for PCI confusion and/or prevent maximum limits for cell neighbors from being exceeded prior to enabling radio unit sharing. If any such confusion or if maximum limits are exceeded, the radio unit services may not be shared.

The above described systems and methods are provided to maintain wireless coverage to wireless devices 110 in faulty or low load sectors. FIG. 10 illustrates an example wireless communication device 110 according to certain embodiments. Examples of wireless communication device 110 include a mobile phone, a smart phone, a PDA (Personal Digital Assistant), a portable computer (e.g., laptop, tablet), a sensor, a modem, a machine type (MTC) device/machine to machine (M2M) device, laptop embedded equipment (LEE), laptop mounted equipment (LME), USB dongles, a device-to-device capable device, or another device that can provide wireless communication. A wireless communication device 110 may also be referred to as user equipment (UE), a station (STA), a mobile station (MS), a device, a wireless device, or a terminal in some embodiments. Wireless communication device 110 includes transceiver 1010, processor 1020, and memory 1030. In some embodiments, transceiver 1010 facilitates transmitting wireless signals to and receiving wireless signals from network node 120 (e.g., via an antenna 1140), processor 1020 executes instructions to provide some or all of the functionality described above as being provided by wireless communication device 110, and memory 1030 stores the instructions executed by processor 1020.

Processor 1020 includes any suitable combination of hardware and software implemented in one or more modules to execute instructions and manipulate data to perform some or all of the described functions of wireless communication device 110. In some embodiments, processor 1120 includes, for example, one or more computers, one or more central processing units (CPUs), one or more microprocessors, one or more applications, and/or other logic.

Memory 1030 is generally operable to store instructions, such as a computer program, software, an application including one or more of logic, rules, algorithms, code, tables, etc. and/or other instructions capable of being executed by a processor. Examples of memory 1030 include computer memory (for example, Random Access Memory (RAM) or Read Only Memory (ROM)), mass storage media (for example, a hard disk), removable storage media (for example, a Compact Disk (CD) or a Digital Video Disk (DVD)), and/or or any other volatile or non-volatile, non-transitory computer-readable and/or computer-executable memory devices that store information.

Other embodiments of wireless communication device 110 include additional components (beyond those shown in FIG. 10) responsible for providing certain aspects of the wireless communication device's functionality, including any of the functionality described above and/or any additional functionality (including any functionality necessary to support the solution described above).

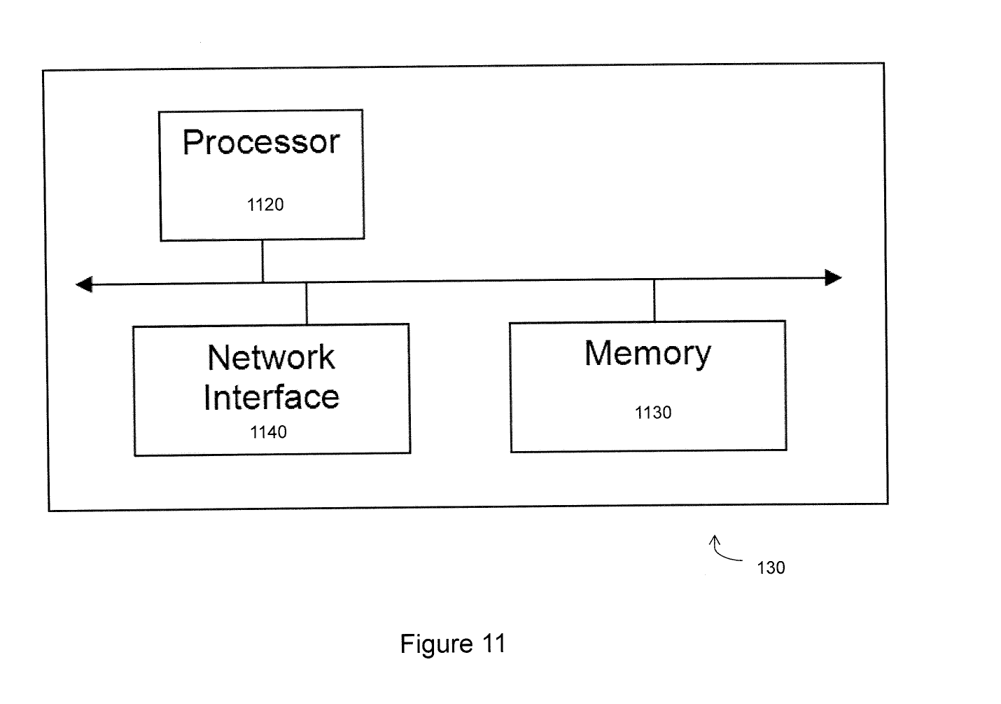

FIG. 11 is a block diagram illustrating a core network node 130. Examples of core network node 130 can include a mobile switching center (MSC), a serving GPRS support node (SGSN), a mobility management entity (MME), a radio network controller (RNC), a base station controller (BSC), and so on. Core network node 130 includes processor 1120, memory 1130, and network interface 1140. In some embodiments, processor 1120 executes instructions to provide some or all of the functionality described above as being provided by core network node 130, memory 1130 stores the instructions executed by processor 1120, and network interface 1140 communicates signals to an suitable node, such as a gateway, switch, router, Internet, Public Switched Telephone Network (PSTN), network nodes 120, other core network nodes 130, etc.

Processor 1120 includes any suitable combination of hardware and software implemented in one or more modules to execute instructions and manipulate data to perform some or all of the described functions of core network node 120. In some embodiments, processor 1120 includes, for example, one or more computers, one or more central processing units (CPUs), one or more microprocessors, one or more applications, and/or other logic.

Memory 1130 is generally operable to store instructions, such as a computer program, software, an application including one or more of logic, rules, algorithms, code, tables, etc. and/or other instructions capable of being executed by a processor. Examples of memory 1130 include computer memory (for example, Random Access Memory (RAM) or Read Only Memory (ROM)), mass storage media (for example, a hard disk), removable storage media (for example, a Compact Disk (CD) or a Digital Video Disk (DVD)), and/or or any other volatile or non-volatile, non-transitory computer-readable and/or computer-executable memory devices that store information.

In some embodiments, network interface 1140 is communicatively coupled to processor 1120 and may refer to any suitable device operable to receive input for core network node 130, send output from core network node 130, perform suitable processing of the input or output or both, communicate to other devices, or any combination of the preceding. Network interface 1140 includes appropriate hardware (e.g., port, modem, network interface card, etc.) and software, including protocol conversion and data processing capabilities, to communicate through a network.

Other embodiments of core network node 130 include additional components (beyond those shown in FIG. 11) responsible for providing certain aspects of the core network node's functionality, including any of the functionality described above and/or any additional functionality (including any functionality necessary to support the solution described above).

Some embodiments of the disclosure may provide one or more technical advantages. For example, certain embodiments may reduce energy consumption by sharing radio unit hardware among cell sectors of a network node. Specifically, one or more radio units under reduced or no load conditions may be shared with other cell sectors in the same network node. In certain embodiments, MIMO and CDD configurations may be dynamically tuned. For example, a network node may be dynamically switched from a MIMO configuration to a SISO or SIMO configuration based on user load and current quality of service requirements.

Another technical advantage may be that operational expenses may be significantly reduced through energy saving and resource sharing. In certain embodiments, low load and no load cell sectors may be identified for resource sharing to reduce energy consumption. In certain embodiments, the Self Organizing Network (SON) Energy Saving function may be optimized to enable resource sharing based on active cell load while maintaining the same radio coverage with no compromise on live traffic capacity.

Another technical advantage may be that the determination that resource sharing should be implemented may be made based on the loading of the cell sectors in combination with user-defined thresholds. Additionally, the SON algorithm may be optimized to optionally check for PCI confusion and/or prevent maximum limits for cell neighbors from being exceeded prior to enabling radio unit sharing. If any such confusion exists or if maximum limits are exceeded, the radio unit services may not be shared.

Still another technical advantage may be that basic radio coverage may be provided with reduced radio throughput capacity. Energy consumption by multiple radio units may be optimized when radio unit capacity is no longer needed. Each cell sector within a network node may alternate between normal operating mode and a resource sharing/energy saving modes based on instantaneous demand. However, still another technical advantage may be that deactivated radio units may be reactivated as needed based on cell sector load.

Still another technical advantage may be that shared resources can be used to restore coverage loss where radio unit hardware can be lent or otherwise donated when a radio unit fails. In certain embodiments, the MIMO switching decision may be made by the optimized SON algorithm to avoid single point failure in the case of a faulty radio unit. As a result, sector coverage may not be lost and faulty equipment can be replaced during off-peak hours. Another technical advantage may be that operating a radio unit in a resource sharing mode may increase cell availability and reduce power consumption if the radio unit is also operating in a load balancing mode.

Modifications, additions, or omissions may be made to the methods disclosed herein without departing from the scope of the invention. The methods may include more, fewer, or other steps. Additionally, steps may be performed in any suitable order.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure, as defined by the following claims.

Abbreviations used in the preceding description include:
UE: User Equipment
PCI: Physical Cell ID
OSS-RC: Operation Sub System-Radio and Core
RBS: Radio Base Station
BW: Bandwidth
MIMO: Multiple Input Multiple Output
SISO: Single Input Single Output
SIMO: Single Input Multiple Output
PRB: Physical Resource Block
SON: Self Organizing Network
CDD: Cyclic Delay Diversity

1. A network node for reducing power consumption, comprising:
a transceiver comprising a plurality of radio units;
one or more processors; and
a non-transitory computer-readable storage medium further including computer-readable instructions that, when executed by the one or more processors, are configured to:
determine that physical resource block utilization by a first radio unit is less than a predefined threshold;
determine that at least one condition is present indicating the feasibility of the second radio unit for handling service to the first sector and the second sector; and
reconfigure the second radio unit to provide service to the first sector.

2. The network node of claim 1, wherein:
when determining that the at least one condition is present, the one or more processors are further configured to determine that the second radio unit associated with a second sector is configured for at least one of a multi-input multi-output (MIMO) and cyclic delay diversity (CDD); and
when reconfiguring the second radio unit, the at least one processors are further configured to disable the MIMO or CDD configuration in the second radio unit.

3. The network node of claim 1, wherein, when determining that the at least one condition is present, the one or more processors are configured to determine that the second radio unit is not handling any emergency calls.

4. The network node of claim 1, wherein, when determining that the at least one condition is present, the one or more processors are configured to determine that the second radio unit is low loaded with specific user defined QCI sessions being less than a first predefined threshold.

5. The network node of claim 1, wherein, when determining that the physical resource block utilization by the first radio unit is less than a predefined threshold, the one or more processors are further configured to determine that a total number of physical resource block pairs used for data radio bearers in a downlink direction and a total number of physical resource block pairs used for data radio bearers in an uplink direction is equal to zero.

6. The network node of claim 1, wherein the one or more processors are further configured to:
reconfigure the second radio unit to provide service for all of the plurality of radio units; and
disable each of the plurality radio units other than the second radio unit.

7. A method for reducing power consumption in a network node including a plurality of radio units, comprising:
determining that physical resource block utilization by a first radio unit within the plurality of radio units is less than a predefined threshold;
determining that at least one condition is present indicating the feasibility of the second radio unit for handling service to the first sector and the second sector; and
reconfiguring the second radio unit to provide service to the first sector.

8. The method of claim 7, wherein:
determining that the at least one condition is present comprises determining that the second radio unit associated with a second sector is configured for at least one of a multi-input multi-output (MIMO) and cyclic delay diversity (CDD); and
reconfiguring the second radio unit comprises disabling the MIMO or CDD configuration in the second radio unit

9. The method of claim 7, wherein determining that the at least one condition is present comprises determining that the second radio unit is not handling any emergency calls.

10. The method of claim 7, wherein determining that the at least one condition is present comprises determining that the second radio unit is low loaded with specific user defined QCI sessions being less than a first predefined threshold.

11. The method of claim 7, wherein determining that the physical resource block utilization by the first radio unit is less than a predefined threshold comprises determining that a total number of physical resource block pairs used for data radio bearers in a downlink direction and a total number of physical resource block pairs used for data radio bearers in an uplink direction is equal to zero.

12. The method of claim 10, further comprising:
reconfiguring the second radio unit to provide service for all of the plurality of radio units; and
disabling each of the plurality radio units other than the second radio unit.

13. A network node for reducing power consumption, comprising:
a transceiver comprising a plurality of radio units;
one or more processors; and
a non-transitory computer-readable storage medium further including computer-readable instructions that, when executed by the one or more processors, are configured to:
determine that physical resource block utilization by a first radio unit is less than a predefined threshold;
determine that the first radio unit is operating with a multi-input multi-output (MIMO) configuration;
determine that the number of active wireless devices service by the first radio unit is less than a second predefined threshold;
reconfigure the first radio unit to provide service for at least one of the plurality of radio units; and
disable the at least one of the plurality radio units other than the first radio unit.

14. The network node of claim 13, wherein the first predefined threshold comprises 30%.

15. The network node of claim 13, wherein determining that the number of active wireless devices serviced by the first radio unit is less than a second predefined threshold comprises determining that a number of mobile nodes active in an uplink direction and a number of mobile nodes active in the downlink direction are equal to zero.

16. The network node of claim 13, wherein:
reconfiguring the first radio unit to provide service for the at least one of the plurality of radio units comprises reconfiguring the first radio unit to provide service for all of the plurality of radio units other than the first radio unit; and
disabling the at least one of the plurality radio units other than the first radio unit comprises disabling all of the plurality of radio units other than the first radio unit.

17. The network node of claim 13, wherein the at least one processor is further configured to:
after the reconfiguration of the first radio unit and the disabling of the at least one of the plurality of radio units, determine that physical resource block utilization by a first radio unit is more than the predefined threshold; and
reconfigure the at least one of the plurality radio units that was disabled to enable it to provide service; and
reconfigure the first radio unit to not provide service for the at least one of the plurality of radio units that was previously disabled.

18. A method for reducing power consumption in a network node, comprising:
determining that physical resource block utilization by a first radio unit is less than a first predefined threshold;
determining that the first radio unit is operating with a multi-input multi-output (MIMO) configuration;
determining that the number of active wireless devices serviced by the first radio unit is less than a second predefined threshold;
reconfiguring the first radio unit to provide service for at least one of the plurality of radio units; and
disable the at least one of the plurality radio units other than the first radio unit.

19. The method of claim 18, wherein the first predefined threshold comprises 30%.

20. The method of claim 18, wherein determining that the number of active wireless devices serviced by the first radio unit is less than a second predefined threshold comprises determining that a number of mobile nodes active in an uplink direction and a number of mobile nodes active in the downlink direction are equal to zero.

21. The method of claim 18, wherein:
reconfiguring the first radio unit to provide service for the at least one of the plurality of radio units comprises reconfiguring the first radio unit to provide service for all of the plurality of radio units other than the first radio unit; and
disabling the at least one of the plurality radio units other than the first radio unit comprises disabling all of the plurality of radio units other than the first radio unit.

22. The method of claim 18, further comprising:
after the reconfiguration of the first radio unit and the disabling of the at least one of the plurality of radio units, determine that physical resource block utilization by a first radio unit is more than the predefined threshold; and
reconfigure the at least one of the plurality radio units that was disabled to enable it to provide service; and
reconfigure the first radio unit to not provide service for the at least one of the plurality of radio units that was previously disabled.
